(19) United States
(12) Patent Application Publication
(10) Pub. No.: US 2026/0265026 A1
(43) Pub. Date: Sep. 10, 2026

(54) Guiding Mechanism and Worm Gear Winch

(71) Applicants: ZHEJIANG TOPSUN LOGISTIC CONTROL CO., LTD., Taizhou, Zhejiang (CN); TOPSUN INTELLIGENT CONTROL TECHNOLOGY RESEARCH INSTITUTE (HANGZHOU) CO., LTD., Hangzhou, Zhejiang (CN)

(72) Inventors: Dongwen Zhou, Taizhou, Zhejiang (CN); Ling Qiu, Taizhou, Zhejiang (CN); Enhe Xiang, Taizhou, Zhejiang (CN)

(73) Assignees: ZHEJIANG TOPSUN LOGISTIC CONTROL CO., LTD., Taizhou, Zhejiang (CN); TOPSUN INTELLIGENT CONTROL TECHNOLOGY RESEARCH INSTITUTE (HANGZHOU) CO., LTD., Hangzhou, Zhejiang (CN)

(21) Appl. No.: 19/166,059

(22) PCT Filed: Mar. 27, 2023
(86) PCT No.: PCT/CN2023/084102

§ 371 Date: Sep. 17, 2025

(30) Foreign Application Priority Data
Mar. 23, 2023 (CN) 202310295054.4

(51) Int. Cl. B66D 1/14; B60P 7/08; F16H 57/12

(52) U.S. Cl. CPC B66D 1/14; F16H 57/12; B60P 7/0846

(57) ABSTRACT

A guiding mechanism includes a connecting body, wherein the connecting body is provided with plug-in fixing pieces; and an elastic anti-movement guiding body, connected to the connecting body in an elastic structure manner, wherein the elastic anti-movement guiding body is provided with an anti-movement guiding arc surface for preventing movement, a guiding structure playing a role in guiding and used to form a reverse engagement structure is connected to the anti-movement guiding arc surface, and the guiding structure extends in a free state. The guiding mechanism can effectively prevent axial movement during worm transmission, improve transmission stability, and ensure a good transmission effect. Automatic disengagement of a worm can be achieved through the guiding structure, and quick belt winding or unwinding operation can be easily achieved.

### RELATED APPLICATIONS

This application claims priority to PCT Patent Application No. PCT/CN2023/084102 filed Mar. 27, 2023 and China Patent Application No. CN202310295054.4 filed Mar. 23, 2023.

The above applications and all patents, patent applications, articles, books, specifications, other publications, documents, and things referenced herein are hereby incorporated herein in their entirety for all purposes. To the extent of any inconsistency or conflict in the definition or use of a term between any of the incorporated publications, documents, or things and the text of the present document, the definition or use of the term in the present document shall prevail.

### TECHNICAL FIELD

The present disclosure relates to the field of winches, in particular to a guiding mechanism and a worm gear winch.

### BACKGROUND

A winch, also known as a hoist, is a light and small lifting device that winds a steel wire rope or a chain with a reel to lift or pull heavy objects. The winch is widely used due to its advantages such as high versatility, a compact structure, a small size, a low weight, a high lifting capacity, and convenient use and transfer.

For example, during the transportation of goods by a car, the goods usually need to be tied up to prevent loss or damage of the goods caused by falling or mutual collision of the goods while the car is running. Although a manner of directly tying the goods with ropes is commonly used, it is time-consuming and labor-intensive, and the goods are difficult to be tighten. Using the winch to tie the goods is both convenient and safe, and is highly popular among drivers. Especially the winch with worm gear transmission is widely used.

However, in the prior art, there is a problem of worm movement and poor stability in the use of the winch with worm gear transmission, which brings great inconvenience to operation and use. Moreover, a worm wheel and a worm in the winch are in an engagement state for a long time, which is prone to leading to a reduction in transmission performance and affecting the service life of the winch.

For example, a “manual small winch” disclosed in Chinese patent literature, with a publication number CN202575797U, includes a housing, a worm, a worm wheel, a transmission shaft, a bearing seat, a roller, and a rocking handle. The worm and the worm wheel are installed in the housing, the worm is in transmission connection with the worm wheel, the rocking handle is arranged on an outer side of the housing, the rocking handle is connected to the worm, the transmission shaft is respectively fixed to the worm wheel and the roller through positioning keys, and the bearing seat is arranged on one side of the roller. One end of the transmission shaft is installed on the housing, and the other end is installed on the bearing seat. The above technical solution also adopts a worm gear driven winch, which has reasonable structural design and is convenient to operate. The winch can also be manually operated without a power source, thereby expanding a range of use and saving energy. However, during the use of this technical solution, there are also problems such as likely movement of the worm and poor stability, and meanwhile, there are problems of difficulty in quickly winding or unwinding a belt and the like.

### SUMMARY

An objective of the present disclosure is to overcome the problems of likely movement of a worm, poor stability, and difficulty in quickly winding or unwinding a belt of a winch with worm gear transmission in the prior art. Thus, the present disclosure provides a guiding mechanism and a winch with the guiding mechanism, in which worm movement can be effectively prevented, a guiding function is good, a worm has an automatic disengagement function, the belt winding and unwinding operation can be easily and quickly achieved, the use strength of the winch can be effectively improved, the service life of the winch can be effectively prolonged, time and effort in operation are saved, the structure is simple, the cost is low, and producing and promotion are convenient.

The technical solution adopted by the present disclosure to achieve its first invention objective is: a guiding mechanism, including:
a connecting body, wherein the connecting body is provided with plug-in fixing pieces; and
an elastic anti-movement guiding body, connected to the connecting body in an elastic structure manner, wherein the elastic anti-movement guiding body is provided with an anti-movement guiding arc surface for preventing movement, a guiding structure playing a role in guiding and used to form a reverse engagement structure is connected to the anti-movement guiding arc surface, and the guiding structure extends in a free state.

The guiding mechanism is connected to the housing of a worm gear transmission mechanism by arranging the connecting body, and is limited and fixed through the plug-in fixing piece, thereby achieving installation and positioning of the guiding mechanism. One elastic anti-movement guiding body is arranged on the connecting body in the elastic structure manner, and the anti-movement guiding arc surface is arranged on the elastic anti-movement guiding body. Axial movement during a worm transmission process is prevented through the anti-movement guiding arc surface, the stability of the worm gear transmission can be effectively improved, and a good transmission effect is achieved. The guiding structure is connected to the anti-movement guiding arc surface, and automatic disengagement of a worm can be achieved through the guiding structure. Specifically, because the elastic anti-movement guiding body has certain elasticity and can produce certain deformation, when the worm needs to disengage from a worm wheel, the worm is reversely rotated, a tip cone of the worm pushes the anti-movement guiding arc surface to move away from the worm, the elastic anti-movement guiding body deforms, the worm and the guiding structure form a reverse engagement structure, and the worm is disengaged outward along the guiding structure, thereby realizing automatic disengagement operation of the worm and the worm wheel. At this point, quick belt winding or unwinding operation can be easily achieved, and the winch may also be in an idle and stress-free state, thereby ensuring use strength of the worm gear transmission mechanism and effectively prolonging the service life of the winch. When the worm wheel needs to be engaged with the worm for transmission, the worm can be quickly advanced to be engaged with the worm wheel through the guiding structure. The guiding mechanism is provided with an elastic structure, can produce certain deformation, has high strength, is not prone to breaking, and will not affect the worm gear transmission. Meanwhile, the guiding mechanism facilitates automatic disengagement, and time and effort in operation are saved.

Preferably, the anti-movement guiding arc surface is arranged as an inclined arc surface and is inclined toward one side of the guiding structure. The anti-movement guiding arc surface is arranged as the inclined arc surface, so that movement prevention is achieved without affecting the transmission of the worm. Therefore, movement prevention is achieved, and the transmission effect can be ensured.

Preferably, the guiding structure includes a guiding convex portion and a guiding concave portion which are arranged in a spaced manner, and a guiding-out portion is arranged at a free end of the guiding structure. The guiding structure is first formed through a structure of the guiding convex portion and the guiding concave portion, and is used to form a structure reversely engaged with the worm, thereby achieving smooth disengagement of the worm. The arrangement of the guiding-out portion at the free end of the guiding structure is to facilitate the disengagement of the worm and meanwhile further ensure that the worm is smoothly advanced to be engaged with the worm wheel.

Preferably, the connecting body is of a U-shaped structure as a whole, and the plug-in fixing pieces are bent in a horizontal structure manner and extend on two sides of a U-Page shaped wall of the connecting body. The connecting body is arranged to be of the U-shaped structure as a whole, which facilitates a connection with a worm gear transmission housing, thereby ensuring the elastic deformation of the elastic anti-movement guiding body, and playing a role in preventing movement and guiding.

Preferably, the elastic anti-movement guiding body and the connecting body are integrally stamped and formed, and the elastic structure is a slot formed between the elastic anti-movement guiding body and the connecting body. The elastic anti-movement guiding body and the connecting body are integrally stamped and formed, which can ensure the strength of the guiding mechanism, the guiding mechanism is not prone to breaking, and the use performance is improved. In order to achieve the certain elasticity of the integrally stamped and formed elastic anti-movement guiding body, the slot is arranged to be of an elastic structure. During use, the elastic anti-movement guiding body can produce certain deformation, thereby achieving movement prevention and guiding functions.

Preferably, the elastic anti-movement guiding body includes a guiding main body, the guiding structure extends outward along one side of the guiding main body, and the other side of the guiding main body extends to be provided with an L-shaped limiting-fixing body. The L-shaped limiting-fixing body and the plug-in fixing pieces on the connecting body are arranged to form an integrated limiting-fixing structure, thus stability is good, and limiting and fixing are convenient.

The technical solution adopted by the present disclosure to achieve its second invention objective is: a worm gear winch, including the described guiding mechanism, wherein the guiding mechanism is elastically and movably arranged and cooperates with a worm to form an anti-movement structure and an automatic-disengagement reverse engagement structure. The worm gear winch can effectively prevent axial movement of the worm through the arrangement of the guiding mechanism. When the worm rotates forward, the guiding mechanism prevents the axial movement of the worm and does not cause the worm to disengage from a worm wheel. When automatic disengagement is required, the worm is reversely rotated, the worm and the guiding structure form the reverse engagement structure, and the worm is disengaged outward along the guiding structure, thereby realizing automatic disengagement operation of the worm and the worm wheel. At this point, quick belt winding or unwinding operation may be easily achieved, and the winch may also be in an idle and stress-free state, ensuring the use strength of a worm gear transmission mechanism and effectively prolonging the service life of the winch.

Preferably, the worm gear winch further includes a worm gear driven housing, a T-shaped limiting groove is formed in one side of an inner wall of the housing close to the worm, the connecting body on the guiding mechanism is inserted into the T-shaped limiting groove and limited and fixed by a T-shaped crimping fixing block, and the elastic anti-movement guiding body extends freely toward one side of the worm in an elastically movable manner. The T-shaped limiting groove is formed in the housing to facilitate limiting and fixing of the connecting body, and at the same time, the elastic anti-movement guiding body can be elastically and movably arranged, and then cooperates with the worm to prevent movement and play a role in guiding.

Preferably, an elastic movable space is formed between the elastic anti-movement guiding body and the inner wall of the housing, and a spacing H between the anti-movement guiding arc surface on the elastic anti-movement guiding body and a tip circle of the worm gradually decreases until the anti-movement guiding arc surface makes contact with the outermost tip circle on the worm to form the anti-movement structure; and the guiding structure on the elastic anti-movement guiding body is reversely engaged with the worm to form the reverse engagement structure. The elastic movable space is formed between the elastic anti-movement guiding body and the inner wall of the housing, thereby ensuring sufficient elastic deformation space for the elastic anti-movement guiding body during a movement prevention and reverse engagement guidance process.

Preferably, the worm gear winch further includes a winch bracket and a belt winding shaft rotatably arranged on the winch bracket, wherein the belt winding shaft and the worm wheel are coaxially arranged, and a handwheel with a damping spring is arranged on the belt winding shaft. In the process of quick belt winding or unwinding, due to certain resilience force of a belt rope, in order to ensure stability of the belt winding or unwinding process, the damping spring is arranged on the handwheel to ensure that there is no rebound during the quick belt winding or unwinding process.

The present disclosure has the beneficial effects that the guiding mechanism can effectively prevent axial movement during worm transmission, improve transmission stability, and ensure a good transmission effect. Automatic disengagement of the worm can be achieved through the guiding structure, the quick belt winding or unwinding operation can be easily achieved, and the winch may also be in the idle and stress-free state, thereby ensuring the use strength of the worm gear transmission mechanism and effectively prolonging the service life of the winch. When the worm wheel needs to be engaged with the worm for transmission, the worm can be quickly advanced through the guiding structure to be engaged with the worm wheel. The guiding mechanism is integrally stamped and formed, and provided with the elastic structure. Thus the guiding mechanism can produce certain deformation, has high strength, is not prone to breaking, and will not affect the worm gear transmission. Meanwhile, the guiding mechanism further facilitates automatic disengagement, and time and effort in operation are saved.

### BRIEF DESCRIPTION OF THE DRAWINGS

FIG. 1 is a schematic structural diagram of a guiding mechanism in the present disclosure.

FIG. 2 is a schematic structural diagram in which a guiding mechanism cooperates with a worm to form an anti-movement structure in the present disclosure.

FIG. 3 is a schematic structural diagram in which a guiding mechanism cooperates with a worm to form an inverse engagement structure in the present disclosure.

FIG. 4 is a schematic structural diagram of an application of a guiding mechanism in the present disclosure.

FIG. 5 is a schematic structural diagram of a worm gear winch in the present disclosure.

FIG. 6 is a schematic structural diagram of a worm gear winch (with a handwheel removed) in the present disclosure.

FIG. 7 is a schematic structural diagram of a worm gear winch (with a housing end cover removed) in the present disclosure.

FIG. 8 is a schematic structural diagram of a worm gear winch (with a housing end cover removed) from another perspective in the present disclosure.

FIG. 9 is an enlarged view of a position A in FIG. 8.

FIG. 10 is a schematic structural diagram of cooperation between a guiding mechanism in an installed state and a worm wheel as well as a worm in the present disclosure.

In the figures: 1. Connecting body, 2. Elastic anti-movement guiding body, 3. Guiding main body, 4. Anti-movement guiding arc surface, 5. Guiding structure, 6. Slot, 7. L-shaped limiting-fixing body, 8. Guiding convex portion, 9. Guiding concave portion, 10. Guiding-out portion, 11. Plug-in fixing piece, 12. Winch bracket, 13. Housing, 14. Worm wheel, 15. Worm, 16. Reverse engagement structure, 17. Belt winding shaft, 18. Handwheel, 19. T-shaped limiting groove, 20. T-shaped crimping fixing block, 21. Elastic movable space, 22. Damping spring, 23. Housing end cover, 24. Anti-movement structure, 25 Worm connecting portion, H. Distance between anti-movement guiding arc surface and tip circle of worm.

### DETAILED DESCRIPTION

The technical solutions of the present disclosure will be further explained below in detail through specific examples in conjunction with accompanying drawings.

### Embodiment 1

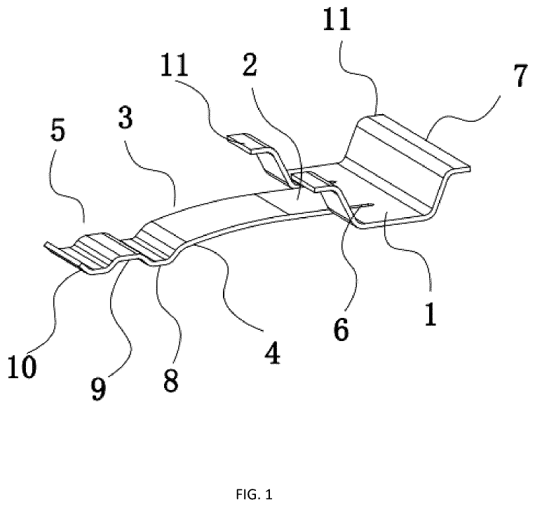

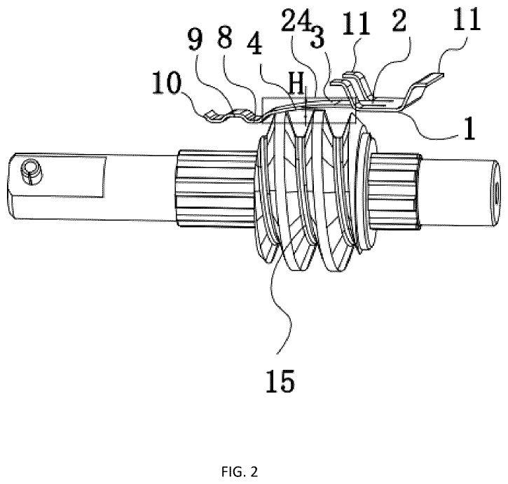

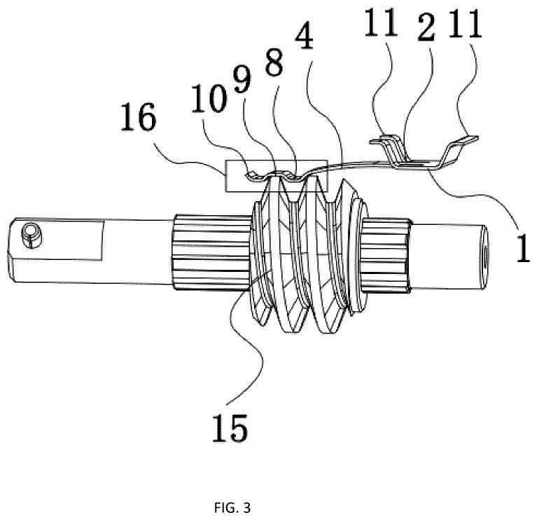

In embodiments shown in FIG. 1, FIG. 2 and FIG. 3, a guiding mechanism includes a connecting body 1, an elastic anti-movement guiding body 2 is integrally stamped and formed on the connecting body 1, the elastic anti-movement guiding body 2 includes a guiding main body 3, an anti-movement guiding arc surface 4 for preventing axial movement of a worm 15 and a guiding structure 5 playing a role in guiding and used to form a reverse engagement structure 16 are arranged on the guiding main body 3 in an elastic structure manner, and the guiding structure 5 extends in a free state. A slot 6 for forming an elastic structure is formed between the guiding main body 3 and the connecting body 1. An L-shaped limiting-fixing body 7 extends on the guide main body 3 in a direction opposite to the anti-movement guiding arc surface 4.

As shown in FIG. 2, the anti-movement guiding arc surface 4 extends outward along the elastic anti-movement guiding body 2, and an arc shape of the anti-movement guiding arc surface 4 is inclined outward from one end of the elastic anti-movement guiding body 2, and is inclined toward one side of the guiding structure 5, so that during use, a distance H between the anti-movement guiding arc surface 4 and a tip circle of the worm 15 gradually decreases until the anti-movement guiding arc surface 4 makes contact with the outermost tip circle of the worm 15.

As shown in FIG. 1 and FIG. 2, the guiding structure 5 extends outward in a free state from a contact end between the anti-movement guiding arc surface 4 and the worm 15, when the worm 15 is in normal transmission use state, the guiding structure 5 is lower than a tip line of the worm 15, and the guiding structure 5 is arranged away from an engagement position of a worm wheel and the worm. As shown in FIG. 1 and FIG. 3, the guiding structure 5 includes guiding convex portions 8 and a guiding concave portion 9 which are arranged in a spaced manner. At least two guiding convex portions 8 are provided, and at least one guiding concave portion 9 is provided. One of the guiding convex portions 8 is in smooth arc-surface butt joint with the anti-movement guiding arc surface 4, and the guiding convex portions 8 are in smooth arc-surface butt joint with the guiding concave portion 9. In the present embodiment, two guiding convex portions 8 and one guiding concave portion 9 are arranged. The guiding concave portion 9 is arranged between the two guiding convex portions 8, and an end part of each guiding convex portion 8 at a free end of the guiding structure 5 is provided with a guiding-out portion 10 bent upward. The guiding convex portions 8 and the guiding concave portion 9 cooperate with the worm 15 to form the reverse engagement structure 16.

Because the elastic anti-movement guiding body 2 has certain elasticity and can produce certain deformation, when the worm 15 needs to disengage from the worm wheel 14, the worm 15 is reversely rotated, a tip cone of the worm 15 pushes the anti-movement guiding arc surface 4 to move away from the worm 15, the elastic anti-movement guiding body 2 deforms, and the worm 15 disengages outward along the guiding structure 5 and slides out of the guiding-out portion 10 when engagement with the guiding structure 5 is ended, thereby realizing automatic disengagement operation of the worm 15 and the worm wheel 14. The quick belt winding or unwinding operation can be easily achieved, and the winch may also be in an idle and stress-free state, thereby ensuring use strength of a worm gear transmission mechanism and effectively prolonging the service life of the winch. When the worm wheel 14 needs to be engaged with the worm 15 for transmission, the worm 15 enters the guiding structure 5 through guiding of the guiding-out portion 10, and then is engaged with the worm wheel 14.

In the present embodiment, two connecting bodies 1 being of a U-shaped structure as a whole are provided, and the two connecting bodies 1 are symmetrically arranged on two sides of the elastic anti-movement guiding body 2. U-shaped bottom surfaces of the connecting bodies 1 are on the same plane as the guiding main body 3, and two side edges of U-shaped grooves of the connecting bodies 1 are respectively and horizontally bent and extend to be provided with plug-in fixing pieces 11. The plug-in fixing pieces 11 facing one side away from the guiding structure 5 and the L-shaped limiting-fixing body 7 are of an integrated structure.

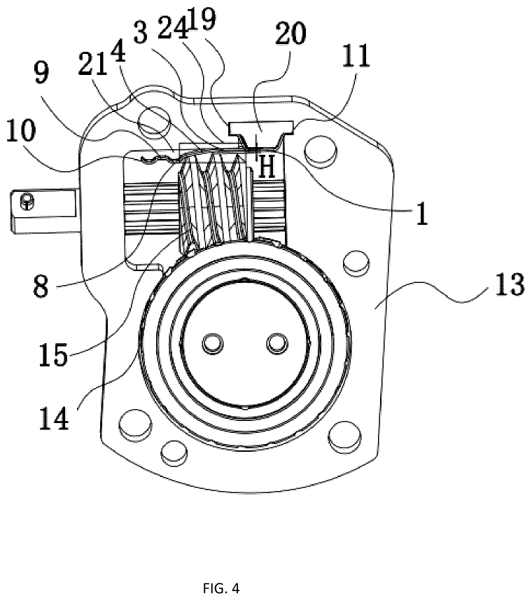

As shown in FIG. 4, during use, a T-shaped limiting groove 19 is formed in a housing 13 of the winch. The connecting bodies 1 on the guiding mechanism are inserted into the T-shaped limiting groove 19, the plug-in fixing pieces 11 on the connecting bodies 1 and the L-shaped limiting-fixing body 7 on the guiding main body 3 are inserted into the T-shaped limiting groove 19, and U-shaped groove bottoms of the connecting bodies 1 are arranged toward the worm 15. A T-shaped crimping fixing block 20 is inserted between the T-shaped limiting groove 19 and the U-shaped groove bottoms of the connecting bodies 1, so as to fix and limit the guiding mechanism. The anti-movement guiding arc surface 4 on the guiding mechanism extends outward along the elastic anti-movement guiding body 2, and an arc shape of the anti-movement guiding arc surface 4 is inclined outward from one end of the elastic anti-movement guiding body 2, so that a distance H between the anti-movement guiding arc surface 4 and a tip circle of the worm 15 gradually decreases until the anti-movement guiding arc surface makes contact with the outermost tip circle of the worm 15.

The guiding structure 5 extends outward in a free state from a contact end between the anti-movement guiding arc surface 4 and the tip circle of the worm 15, and extends roughly in an axial direction of the worm 15. When the worm 15 is in a normal transmission use state, the guiding structure 5 is lower than the tip line of the worm 15, and the guiding structure 5 is arranged away from the engagement position of the worm wheel 14 and the worm 15. That is, the guiding structure is arranged facing one end of a worm connecting portion 25.

An elastic movable space 21 is formed between the elastic anti-movement guiding body 2 on the guiding mechanism and an inner wall of the housing 13, which facilitates the formation of a deformation space during automatic disengagement of the worm 15.

According to the guiding mechanism, when the worm 15 is guided out through the guiding mechanism, the worm wheel 14 disengages from the worm 15. At this time, the worm wheel 14 is in an idle state, and quick belt winding or unwinding operation can be achieved. When the worm wheel 14 needs to be engaged with the worm 15 for transmission, the worm 15 is rotated inward along the guiding mechanism. Since the end of the guiding mechanism is provided with the guiding-out portion 10, the worm 15 can be quickly guided into engagement with the worm wheel 14. Meanwhile, automatic disengagement of the worm 15 can be easily achieved through the guiding structure 5, and the operation is convenient and fast. Moreover, during engagement of the worm wheel 14 and the worm 15, axial movement of the worm 15 is prevented by arranging the anti-movement guiding arc surface 4, thereby ensuring the stability of engagement and achieving stable operation.

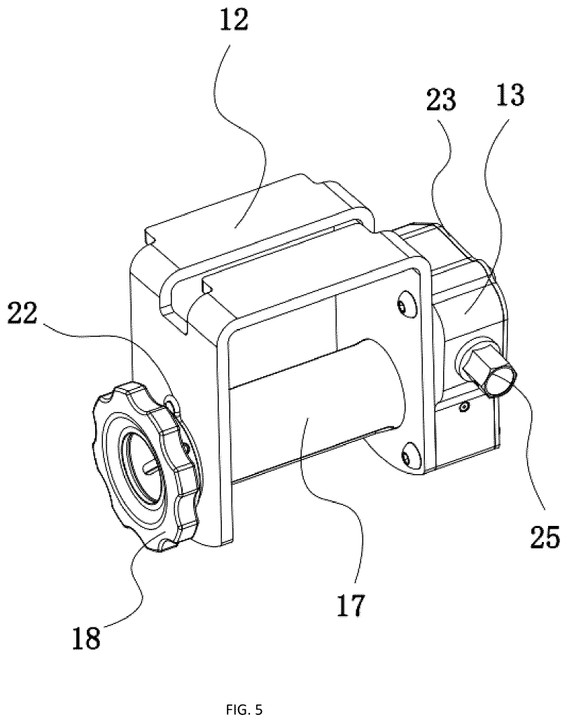

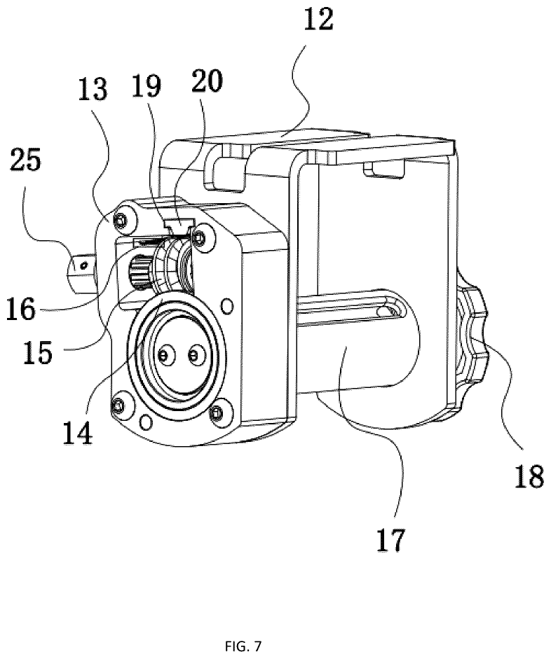

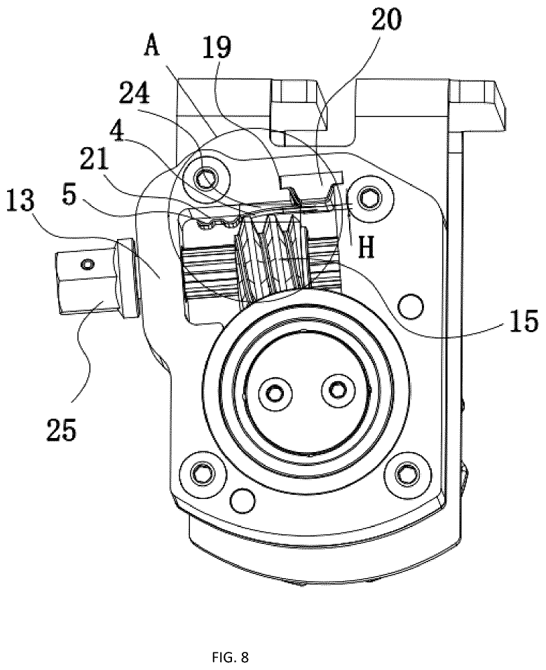

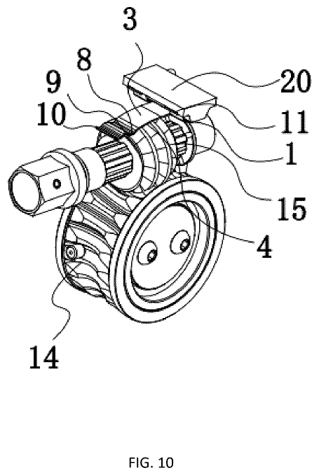

As shown in FIG. 5. FIG. 7, FIG. 8 and FIG. 10, a worm gear winch includes the guiding mechanism. The guiding mechanism is elastically and movably arranged and cooperates with a worm 15 to form an anti-movement structure 24 and an automatic-disengagement reverse engagement structure 16. The worm gear winch further includes a winch bracket 12 arranged to be of a frame structure, a housing 13 arranged on the winch bracket 12 and used for worm gear transmission, a worm gear transmission mechanism arranged inside the housing 13, and a belt winding shaft 17 rotatably arranged on the winch bracket 12.

The housing 13 is arranged on a side surface of one side of the winch bracket 12, and the worm gear transmission mechanism includes a worm wheel 14, a worm 15, and a power mechanism that drives the worm wheel 14 to rotate. The power mechanism may be a manual handwheel or an automatic drive mechanism.

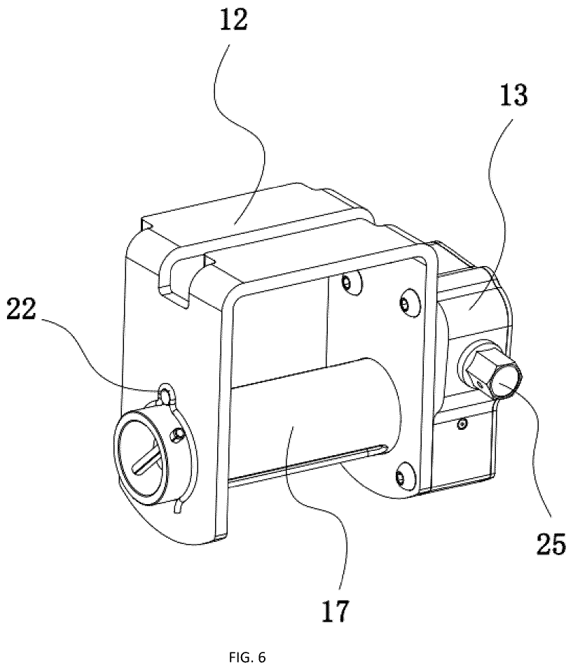

The belt winding shaft 17 stretches over the winch bracket 12, one end of the belt winding shaft 17 is arranged outside the winch bracket 12 away from one side of the housing 13, and the belt winding shaft 17 is provided with a handwheel 18. In order to prevent revolution of belt winding or unwinding in a quick belt winding or unwinding operation process in a disengagement state, as shown in FIG. 6, a damping spring 22 is arranged on an inner side of the handwheel 18 and on the winch bracket 12, and elastic force of the belt is prevented from returning through the damping spring 22. The other end of the belt winding shaft 17 is coaxially connected to the worm wheel 14 and can be driven to rotate by the worm wheel 14. The belt winding shaft 17 can also drive the worm wheel 14 to rotate. In the automatic disengagement state, the belt winding shaft 17 can drive the worm wheel 14 to idle, thereby achieving the quick belt winding or unwinding operation.

One end of the worm 15 extends outside the housing 13, and an extended end of the worm 15 is provided with a worm connecting portion 25. The worm connecting portion 25 may be connected to the manual handwheel to form a manual winch, or may be connected to a driving mechanism to form a power-driven automatic winch.

As shown in FIG. 8, a T-shaped limiting groove 19 is formed in one side of the housing 13 close to the worm 15. A connecting body 1 on the guiding mechanism is inserted into the T-shaped limiting groove 19, plug-in fixing pieces 11 on the connecting body 1 and an L-shaped limiting-fixing body 7 on a guiding main body 3 are inserted into the T-shaped limiting groove 19, and a U-shaped groove bottom of the connecting body 1 is arranged toward the worm 15. A T-shaped crimping fixing block 20 is inserted between the T-shaped limiting groove 19 and the U-shaped groove bottom of the connecting body 1, so as to fix and limit the guiding mechanism. An elastic anti-movement guiding body 2 freely extends toward one side of the worm 15 in an elastically movable manner. An anti-movement guiding arc surface 4 on the guiding mechanism extends outward along the elastic anti-movement guiding body 2, and an arc shape of the anti-movement guiding arc surface 4 is inclined outward from one end of the elastic anti-movement guiding body 2, so that a distance H between the anti-movement guiding arc surface 4 and a tip circle of the worm 15 gradually decreases until the anti-movement guiding arc surface 4 makes contact with the outermost tip circle of the worm 15. As shown in FIG. 3, a guiding convex portion 8 and a guiding concave portion 9 cooperate with the worm 15 to form the reverse engagement structure 16.

The guiding structure 5 extends outward in a free state from a contact end between the anti-movement guiding arc surface 4 and the tip circle of the worm 15, and extends roughly in an axial direction of the worm 15. When the worm 15 is in a normal transmission use state, the guiding structure 5 is lower than a tip line of the worm 15, and the guiding structure 5 is arranged away from an engagement position of the worm wheel 14 and the worm 15. That is, the guiding structure is arranged facing one end of the worm connecting portion 25.

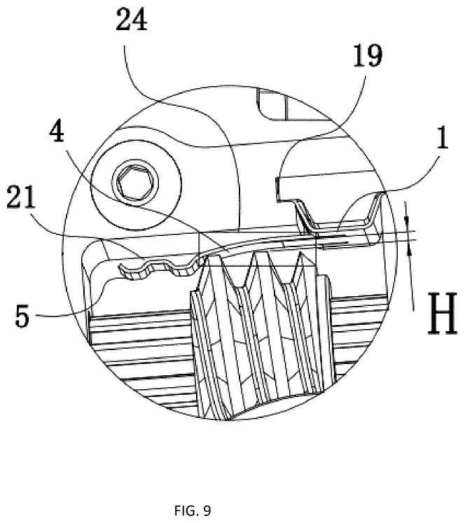

As shown in FIG. 9, an elastic movable space 21 is formed between the elastic anti-movement guiding body 2 on the guiding mechanism and an inner wall of the housing 13, which facilitates the formation of a deformation space during automatic disengagement of the worm 15. As shown in FIG. 4, the distance H between the anti-movement guiding arc surface 4 on the elastic anti-movement guiding body 2 and the tip circle of the worm 15 gradually decreases until the anti-movement guiding arc surface 4 makes contact with the outermost tip circle on the worm 15 to form the anti-movement structure 24. As shown in FIG. 3, the guiding structure 5 on the elastic anti-movement guiding body 2 is reversely engaged with the worm 15 to form the reverse engagement structure 16.

According to the worm gear winch, the belt winding shaft 17 is arranged on the winch bracket 12 in a penetrating manner and is able to rotate on the winch bracket 12. The belt winding shaft 17 is driven by the worm gear transmission mechanism to achieve smooth and stable rotation. In a disengagement state of the worm wheel 14 and the worm 15, quick belt winding or unwinding can be achieved through the belt winding shaft 17 by operating the handwheel 18.

The worm gear winch has a compact structure, beautiful appearance, and good stability performance. A housing end cover 23 is arranged on one side of the housing 13 away from the winch bracket 12. The transmission mechanism is sealed inside the housing 13 through the housing end cover 23, thereby ensuring the cleanliness inside the housing 13 and preventing debris from entering in the housing 13. This ensures worm gear transmission and more stability of the guiding mechanism during use.

The worm gear winch can effectively prevent axial movement of the worm 15 through the arrangement of the guiding mechanism. When the worm 15 rotates forward, the guiding mechanism prevents the axial movement of the worm 15 and does not cause the worm 15 to disengage from the worm wheel 14. When automatic disengagement is required, the worm 15 is reversely rotated, the worm 15 and the guiding structure 5 form the reverse engagement structure 16, and the worm is disengaged outward along the guiding structure 5, thereby realizing automatic disengagement operation of the worm 15 and the worm wheel 14. At this point, the quick belt winding or unwinding operation may be easily achieved, and the winch may also be in an idle and stress-free state, ensuring the use strength of the worm gear transmission mechanism and effectively prolonging the service life of the winch. Moreover, the guiding mechanism is stamped and formed as a whole, has high strength, is not prone to breakage, and has a good use effect. The guiding mechanism is provided with the elastic structure, which has certain elasticity and can produce certain deformation without affecting the worm gear transmission. At the same time, automatic disengagement is facilitated. The arrangement of the damping spring 22 at the handwheel ensures that there will be no reverse rotation or backspin phenomenon during fast belt winding or unwinding operation.

The above embodiments are only a part of the embodiments of the present disclosure, not all of them. Meanwhile, on the basis of the embodiments in the present disclosure, all other embodiments obtained by those ordinarily skilled in the art without inventive efforts based on the technical solutions of the present application should fall within the scope of protection of the present disclosure.

1. A guiding mechanism, comprising:
a connecting body, wherein the connecting body is provided with plug-in fixing pieces; and
an elastic anti-movement guiding body, connected to the connecting body in an elastic structure manner, wherein the elastic anti-movement guiding body is provided with an anti-movement guiding arc surface for preventing movement, a guiding structure playing a role in guiding and used to form a reverse engagement structure is connected to the anti-movement guiding arc surface, and the guiding structure extends in a free state.

2. The guiding mechanism according to claim 1, wherein the anti-movement guiding arc surface is arranged as an inclined arc surface and is inclined toward one side of the guiding structure.

3. The guiding mechanism according to claim 1, wherein the guiding structure comprises a guiding convex portion and a guiding concave portion which are arranged in a spaced manner, and a guiding-out portion is arranged at a free end of the guiding structure.

4. The guiding mechanism according to claim 1, wherein the connecting body is of a U-shaped structure as a whole, and the plug-in fixing pieces are bent horizontally and extend on two sides of a U-shaped wall of the connecting body.

5. The guiding mechanism according to claim 1, wherein the elastic anti-movement guiding body and the connecting body are integrally stamped and formed, and an elastic structure is a slot formed between the elastic anti-movement guiding body and the connecting body.

6. The guiding mechanism according to claim 1, wherein the elastic anti-movement guiding body comprises a guiding main body, the guiding structure extends outward along one side of the guiding main body, and an L-shaped limiting-fixing body extends on the other side of the guiding body.

7. A worm gear winch, comprising the guiding mechanism according to claim 1, any wherein the guiding mechanism is elastically and movably arranged and cooperates with a worm to form an anti-movement structure and an automatic-disengagement reverse engagement structure.

8. The worm gear winch according to claim 7, wherein the worm gear winch further comprises a housing with worm gear transmission, a T-shaped limiting groove is formed in one side of an inner wall of the housing close to the worm, the connecting body on the guiding mechanism is inserted into the T-shaped limiting groove and limited and fixed by a T-shaped crimping fixing block, and the elastic anti-movement guiding body extends freely toward one side of the worm in an elastically movable manner.

9. The worm gear winch according to claim 8, wherein an elastic movable space is formed between the elastic anti-movement guiding body and the inner wall of the housing, and a distance between the anti-movement guiding arc surface on the elastic anti-movement guiding body and a tip circle of the worm gradually decreases until the anti-movement guiding arc surface makes contact with the outermost tip circle on the worm to form the anti-movement structure; and the guiding structure on the elastic anti-movement guiding body is reversely engaged with the worm to form the reverse engagement structure.

10. The worm gear winch according to claim 7, wherein the worm gear winch further comprising a winch bracket and a belt winding shaft rotatably arranged on the winch bracket, wherein the belt winding shaft and a worm wheel are coaxially arranged, and a handwheel with a damping spring is arranged on the belt winding shaft.
